(19) United States
(12) Patent Application Publication
(10) Pub. No.: US 2026/0169026 A1
(43) Pub. Date: Jun. 18, 2026

(54) NON-FLUORESCENT MOLECULAR SUPER-RESOLUTION IMAGING SYSTEM BASED ON PHOTOTHERMAL RELAXATION LOCALIZATION MICROSCOPE

(71) Applicant: ZHEJIANG UNIVERSITY, HANGZHOU, Zhejiang Province (CN)

(72) Inventors: DELONG ZHANG, HANGZHOU, ZHEJIANG PROVINCE (CN); PENGCHENG FU, HANGZHOU, ZHEJIANG PROVINCE (CN); HYEON JEONG LEE, HANGZHOU, ZHEJIANG PROVINCE (CN)

(21) Appl. No.: 19/129,018

(22) PCT Filed: Sep. 8, 2023
(86) PCT No.: PCT/CN2023/117713

§ 371 Date: May 11, 2025

(30) Foreign Application Priority Data
Nov. 11, 2022 (CN) 202211411914.8

(51) Int. Cl. G01Q 60/18

(52) U.S. Cl. CPC G01Q 60/18

(57) ABSTRACT

The present invention discloses a non-fluorescent molecular super-resolution imaging system based on a photothermal relaxation localization microscope, including a pump light source, a probe light source, a microscope, a photodetector, a multi-order harmonic signal extraction device, and an imaging processing device. After multi-order harmonic demodulation is performed on a probe light modulated by a photothermal effect and photothermal energy dissipation of a sample to be tested, super-resolution imaging is performed according to a high-order harmonic signal extracted from a frequency domain. In this way, super-resolution imaging of molecules or structures with optical absorption can be achieved without fluorescent labeling, fundamentally solving the problems of fluorescent molecules relied on by conventional super-resolution imaging, including various limitations such as photobleaching, labeling efficiency problems, and labeling selectivity problems. Moreover, various limitations of super-resolution fluorescence, such as the need for specially designed fluorescent molecules and the photodamage caused by high-power laser light, are eliminated in principle.

### FIELD OF TECHNOLOGY

The present invention belongs to the field of super-resolution imaging, and specifically relates to a non-fluorescent molecular super-resolution imaging system based on a photothermal relaxation localization microscope.

### BACKGROUND TECHNOLOGY

Optical imaging beyond the diffraction limit provides structural and dynamic insights for in-situ analysis and has found fruitful applications in many fields. As the most widely adopted imaging technology, fluorescence-based super-resolution microscopy breaks through the optical diffraction limit of resolution through the stimulated emission depletion (STED) mechanism or stochastic optical reconstruction (PALM or STORM) to precisely locate the positions of fluorescent molecules. However, such technologies require special fluorescent molecules or complex collection methods. In response to this problem, super-resolution imaging technologies based on the saturation effect of fluorescence have been developed, which break through the resolution by demodulating the high-order harmonics in their intensity modulation, such as saturated excitation microscopy (SAX). However, the most fundamental challenge of these super-resolution imaging techniques comes from the dependence on fluorescent labeling, and their development is limited by the cytotoxicity, labeling efficiency and specificity of fluorescent labels.

Therefore, label-free imaging technology has become a major technical goal. To this end, great efforts have been made for the super-resolution imaging of endogenous biomolecules or materials. Similar to the STED mechanism, the depletion of the electronically excited state has been used to improve the resolution of material imaging, including the saturated transient absorption (STAN) of materials and photoacoustic imaging through the inhomogeneous bleaching of absorbing molecules. Another structured illumination method has been demonstrated on a structured pump-probe microscope. At the same time, the nonlinear response caused by the inhomogeneous intensity at the focal point has been used to improve the resolution, including nonlinear photoacoustic microscopy (NL-PAM) and nonlinear photothermal imaging (NI-PTM). However, most of these technologies are based on the saturation effect of signals and photothermal nonlinearity. Therefore, the types of target molecules for imaging are limited, and high-power pulsed laser light is required, which hinder the widespread application of the above technologies.

In addition to label-free imaging using electronic absorption, vibrational spectroscopy, such as infrared (IR) and Raman spectroscopy, provides molecular structure information based on the vibration of intrinsic molecular states and has been used to develop label-free super-resolution imaging with molecular selectivity, such as structured illumination Raman microscopy. In the past decade, super-resolution imaging based on coherent Raman scattering has been demonstrated, including high-order coherent anti-Stokes Raman scattering (HO-CARS), saturated coherent anti-Stokes Raman scattering and saturated stimulated Raman scattering (SSRS). However, one of the most fundamental limitations of Raman spectroscopy-based technologies is the extremely weak Raman effect. Coherent Raman scattering super-resolution imaging requires an ultrafast laser with a high peak power to excite the high-order optical nonlinearity, which increases the risk of high photodamage and limits its biological applications.

On the other hand, infrared spectroscopy has high sensitivity due to its high scattering cross-section, and features such as low photon energy and extremely low photodamage. In recent years, the mid-infrared photothermal (MIP) imaging technology that has been developed has received increasing attention. The resolution of traditional infrared imaging is limited to a few micrometers due to the diffraction limit, which is far from the resolution of a typical optical microscope. Although near-field infrared imaging technologies, such as atomic force microscope-based infrared spectroscopy (AFM-IR), have achieved nanoscale spatial resolution, the use of physical probes limits their widespread application, especially for intracellular imaging. On the other hand, MIP integrates molecular vibrational spectroscopy technology into photothermal imaging technology, demonstrating three-dimensional imaging of far-field bond selection for living cells and organisms. The resolution of MIP imaging reaches the level of 300 nm. By using a beam of visible light with a short wavelength as the probe light to detect the photothermal effect generated by the absorption of molecular vibrations, it breaks through the diffraction limit of conventional infrared imaging by an order of magnitude. Although MIP imaging meets the requirements of far-field, non-contact and non-invasive infrared imaging technologies, it is still an imaging method limited by the diffraction limit of the probe light, and its resolution is far from meeting the requirements of super-resolution. Therefore, there is currently a lack of a generally applicable label-free super-resolution imaging method in this field.

### SUMMARY

In view of the above, an objective of the present invention is to provide a non-fluorescent super-resolution imaging method based on a photothermal relaxation localization (PEARL) microscope. The method can achieve label-free, highly sensitive, wide-spectral range and low-photodamage far-field super-resolution imaging, achieving a spatial resolution of super-resolution imaging of nearly 100 nm.

To achieve the above objective of the present invention, an embodiment provides a non-fluorescent molecular super-resolution imaging system based on a photothermal relaxation localization microscope, including a pump light source, a probe light source, a microscope, a photodetector, a multi-order harmonic signal extraction device, and an imaging processing device,

where a stage of the microscope carries a sample to be tested and is capable of performing three-dimensional spatial displacement scanning on the sample to be tested, and the microscope is equipped with at least one objective lens for focusing laser light, so that focal points of pump light and probe light overlap;

the pump light source provides pump light in a pulsed form, the pump light is focused on the sample to be tested through the objective lens, the sample to be tested selectively absorbs the pump light, and then dissipates energy through photothermal relaxation and generates a photothermal lens effect;

the probe light source provides continuous probe light, the probe light is focused by the objective lens and irradiated onto the sample to be tested having been acted upon by the pump light, the action of the pump light causes spatial and temporal changes, i.e., modulation, in the probe light, and characteristics of the modulation exhibited in a frequency domain are mainly manifested as follows: at a high-order harmonic frequency, a smaller spatial structure is capable of being detected, and a diffraction limit resolution of the probe light is capable of being exceeded;

the photodetector collects modulated probe light, and converts the modulated probe light into an electrical signal, and then inputs the electrical signal into the multi-order harmonic signal extraction device;

the multi-order harmonic signal extraction device mixes the electrical signal with a sinusoidal signal of a harmonic frequency output by a harmonic generator, and then extracts a multi-order harmonic signal through low-pass filtering; and the imaging processing device performs super-resolution imaging according to multi-order harmonic signals extracted during the three-dimensional spatial displacement scanning, each order of harmonic signal forms an image, where an image with a higher resolution is formed when an order is higher, and images with sequentially increasing resolutions form an image sequence.

Preferably, the super-resolution imaging system includes a first detection optical path, and a first detection mode is realized based on the first detection optical path, where in the first detection mode, the probe light of the probe light source and the pump light of the pump light source are opposite in direction in the objective lens, and the probe light performs backscattering detection on the sample to be tested; and

the first detection optical path is as follows: the pump light output by the pump light source is focused onto the sample to be tested through a second objective lens, the probe light output by the probe light source is transmitted through a beam splitter into a first objective lens, and is focused by the first objective lens and irradiated onto the sample to be tested having been acted upon by the pump light, the probe light modulated by the sample to be tested is reflected back to the beam splitter, and is reflected by the beam splitter and then focused by a lens and passes through a pinhole, and is then filtered by a filter and then received by the photodetector.

Preferably, the super-resolution imaging system includes a second detection optical path, and a second detection mode is realized based on the second detection optical path, where in the second detection mode, the probe light of the probe light source and the pump light of the pump light source are opposite in direction in the objective lens, and the probe light performs forward detection on the sample to be tested; and

the second detection optical path is as follows: the pump light output by the pump light source is transmitted through a dichroic mirror into a second objective lens, and is focused on the sample to be tested through the second objective lens, the probe light output by the probe light source is focused by a first objective lens and irradiated onto the sample to be tested having been acted upon by the pump light, and the probe light modulated by the sample to be tested penetrates the sample to be tested and then enters the dichroic mirror through the second objective lens, and is reflected by the dichroic mirror and then focused by a lens and passes through a pinhole, and is then filtered by a filter and then received by the photodetector.

Preferably, the super-resolution imaging system includes a third detection optical path, and a third detection mode is realized based on the third detection optical path, where in the third detection mode, the probe light of the probe light source and the pump light of the pump light source are in a same direction in the objective lens, and the probe light performs backscattering detection on the sample to be tested; and

the third detection optical path is as follows: the pump light output by the pump light source is reflected by a dichroic mirror into a first objective lens, and is focused on the sample to be tested through the first objective lens, the probe light output by the probe light source is transmitted through a beam splitter and then transmitted through the dichroic mirror into the first objective lens, and is focused by the first objective lens and irradiated onto the sample to be tested having been acted upon by the pump light, and the probe light modulated by the sample to be tested is reflected back to the dichroic mirror by the first objective lens, transmitted through the dichroic mirror and then reflected by the beam splitter, focused by a lens and passes through a pinhole, and is then filtered by a filter and then received by the photodetector.

Preferably, the super-resolution imaging system includes a fourth detection optical path, and a fourth detection mode is realized based on the fourth detection optical path, where in the fourth detection mode, the probe light of the probe light source and the pump light of the pump light source are in a same direction in the objective lens, and the probe light performs forward detection on the sample to be tested; and

the fourth detection optical path is as follows: the pump light output by the pump light source is reflected by a dichroic mirror into a first objective lens, and is focused on the sample to be tested through the first objective lens, the probe light output by the probe light source is transmitted through the dichroic mirror into the first objective lens, and is focused by the first objective lens and irradiated onto the sample to be tested having been acted upon by the pump light, and the probe light modulated by the sample to be tested penetrates the sample to be tested, then passes through the second objective lens, is focused by a lens and passes through a pinhole into a filter, and is then filtered and then received by the photodetector.

Preferably, the probe light output by the probe light source is first filtered by a single-mode optical fiber and then transmitted through an optical path to the first objective lens.

Preferably, the probe light source emits continuous probe light of ultraviolet and visible light.

Preferably, the multi-order harmonic signal extraction device adopts a multi-channel digital lock-in amplifier, and the multi-channel digital lock-in amplifier performs multi-order harmonic demodulation on the input electrical signal to extract a multi-order harmonic signal in the frequency domain; and

when the multi-channel digital lock-in amplifier is utilized to perform multi-order harmonic demodulation on the input electrical signal, a fundamental frequency adopted is a pulse repetition frequency of the pump light source.

Preferably, for mid-infrared light, the objective lens adopted is a reflective objective lens, including a Cassegrain objective lens and a Schwarzschild objective lens, and the reflective objective lens is configured to perform focusing optimization on focusing of the pump light in a mid-infrared band.

Preferably, the objective lens adopted is a high numerical aperture objective lens, including an air lens, a water immersion objective lens, and an oil immersion objective lens, and the high numerical aperture objective lens is configured to perform focusing optimization on focusing of the probe light.

Compared with the prior art, the beneficial effects of the present invention include at least the following:
(1) After multi-order harmonic demodulation is performed on a probe light modulated by a photothermal effect and photothermal energy dissipation of a sample to be tested, super-resolution imaging is performed according to a high-order harmonic signal extracted from a frequency domain. In this way, super-resolution imaging of molecules or structures with optical absorption can be achieved without fluorescent labeling, fundamentally solving the problems of fluorescent molecules relied on by conventional super-resolution imaging, including various limitations such as photobleaching, labeling efficiency problems, and labeling selectivity problems. Moreover, various limitations of super-resolution fluorescence, such as the need for specially designed fluorescent molecules and the photodamage caused by high-power laser light, are eliminated in principle.
(2) Compared with the traditional diffraction-limited photothermal imaging, the present invention further breaks through the resolution limit of the probe light, and the resolution is superior to that of traditional photothermal imaging. Both the lateral and axial resolutions have been significantly improved. Especially in the photothermal high-order harmonic extraction imaging under mid-infrared pumping, it is possible to detect and distinguish smaller lipid droplets and protein structures in cells.
(3) The pump light power dependence of the present invention is linear at photothermal high-order harmonics, avoiding the extremely high pump light energy required for conventional nonlinear photothermal excitation and the photodamage it causes to the sample.
(4) The present invention has wide compatibility. Based on a typical photothermal imaging microscope, the super-resolution function can be obtained by applying the present invention, and an image sequence from the fundamental frequency to the high-order harmonics can be output simultaneously. Moreover, the present invention is designed to be compatible with both fluorescence imaging and nonlinear photothermal imaging.
(5) The present invention has no limitations on the absorption of the involved light, including but not limited to electronic absorption, vibrational absorption, and rovibrational absorption, etc., and has practical applications in multiple fields such as materials science, biology, and medicine.

### BRIEF DESCRIPTION OF THE DRAWINGS

In order to describe the technical solutions in the embodiments of the present invention or in the prior art more clearly, the following briefly describes the drawings required for describing the embodiments or the prior art. It is obvious that the drawings in the following description show some embodiments of the present invention. For those of ordinary skill in the art, other drawings can also be obtained based on these drawings without creative efforts.

FIG. 1 shows a principle of photothermal relaxation imaging provided in an embodiment, where (a) is an energy level diagram and temperature response of a photothermal process; (b) is a photothermal (PT) process excited by a pulse sequence, and a sample switches between two states of heating (I) and photothermal dissipation (II); (c) shows photothermal signals detected at a center and an edge of an object, and due to the position-dependent photothermal dissipation, they exhibit different relaxation properties. That is, since an expansion effect at the edge is more obvious, the work done outward leads to a relatively low temperature rise at this position; (d) shows harmonic components detected at the center and the edge in (c), where H1, H2, . . . , Hn are demodulation harmonic orders; (e) is a simulation calculation result of 1st-order harmonic temperature response of two 200 nm microspheres with a distance of 40 nm therebetween; (f) is a simulation calculation result of 9th-order harmonic temperature response of two 200 nm microspheres with a distance of 40 nm therebetween, and a scale is 200 nm; (g) is a temperature evolution process at a center and an edge of a lower sphere; and (h) is an intensity ratio of a middle signal to an edge signal at 1st- to 9th-order harmonics;

FIG. 2 is a structural diagram of a non-fluorescent molecular super-resolution imaging system provided in an embodiment;

FIG. 3 is a schematic diagram of a multi-order harmonic signal extraction device provided in an embodiment extracting multi-order harmonic signals;

FIG. 4 is a schematic diagram of four detection modes provided in an embodiment, where (a) is backscattering detection with counter-propagating pumping; (b) is forward detection with counter-propagating pumping; (c) is backscattering detection with co-propagating pumping; (d) is forward detection with co-propagating pumping;

FIG. 5 is performance characterization of E-PEARL imaging and applications of cell imaging provided in an embodiment, where (a) is a TEM image of 30 nm synthesized gold nanoparticles (AuNPs), and the scale is 100 nm; (b) is traditional photothermal imaging (H1) of gold nanoparticles; (c) is E-PEARL imaging of a single 30 nm gold nanoparticle at different harmonic orders; (d) is axial E-PEARL imaging at 1st-, 4th-, 7th-, and 11th-order harmonics, and a scale is 500 nm; (e) is a lateral resolution (points) of PEARL imaging at different harmonic orders and its fitting result (dashed line), and an error bar represents a standard deviation of the two-dimensional Gaussian fitting of the imaging; (f) is a relationship between an E-PEARL signal, a signal-to-noise ratio and a harmonic order for a single gold nanoparticle; (g) is pump light power dependence of an E-PEARL signal of a single 30 nm gold nanoparticle at selected harmonic orders (1, 9, 20); (h) is reflected light imaging of a cell that has phagocytosed gold nanoparticles; (i) is E-PEARL imaging of the gold nanoparticles (AuNP) in the same cell, and the scale is 5 μm; (j) is an enlarged image in (i) for comparing a resolution with traditional photothermal imaging, where a left image is of an H1 order, and a right image is of an H5 order, and a scale is 5 μm; and (k) and (m) are signal intensity profiles indicated by arrows in an H1 order image and an H5 order image in (j);

FIG. 6 is performance characterization of V-PEARL imaging at mid-infrared absorption provided in an embodiment, where (a) is V-PEARL imaging of a 200 nm PMMA microsphere at 1st- to 12th-order harmonics in a 1730 cm⁻¹ C═O band; (b) measures a photothermal relaxation trace of a 2 μm PMMA microsphere, and an edge is 900 nm away from a center; (c) is an FFT of the photothermal relaxation trace in (b); (d) is a harmonic intensity ratio (center/edge) in (c); (e) is a full width at half maximum (FWHM) measured at a half maximum in (a), an error bar represents a standard deviation of two-dimensional Gaussian fitting of imaging, and a scale is 200 nm; (f) is power dependence of a V-PEARL signal of γ-valerolactone during first and fourth harmonic demodulation;

FIG. 7 is V-PEARL imaging of chondrocytes provided in an embodiment, where (a)-(b) are V-PEARL imaging of chondrocytes in a 1750 cm⁻¹ lipid C═O band and a 1650 cm⁻¹ amide I band at 8th harmonic, a dashed circle indicates a cell nucleus, and an arrow indicates a protein droplet and a cytoskeleton; (c) is V-PEARL imaging with a combination of a lipid channel (a) and a protein channel (b); (d) shows photothermal spectra of lipid droplets and protein droplets obtained at points shown in (a) and (b), respectively; (e) shows enlarged images of a same area shown in a dashed box in (a) through conventional MIP (H1) and V-PEARL (H8), and an arrow indicates a small lipid droplet shown in the V-PEARL imaging; and (f) shows signal profiles of 1st and 8th harmonic demodulation indicated by a white arrow in the image (e), and a scale is 10 μm; and

FIG. 8 is V-PEARL imaging of living Saccharomyces cerevisiae cells provided in the embodiment, where (a) is a reflected image of yeast cells; (b) and (c) are V-PEARL images of yeast cells at fourth harmonic demodulation in 1750 cm⁻¹ lipid C═O stretching vibration and a 1650 cm⁻¹ amide I band, respectively; (d) measures size distribution of lipid droplets in (b) at at first harmonic and fourth harmonic demodulation; (e) is spatial frequency spectra of (a), (b) and (c); (f) is reflection imaging of yeast cells, and (g) and (h) are V-PEARL images of yeast cells in a 1750 cm⁻¹ lipid C═O band and a 1650 cm⁻¹ amide I band, respectively; (i) is an overlapping V-PEARL image from white boxes in (b) and (c); (j) shows intensity curves of two droplets in yeast cells (as indicated by arrows in (h)) and Gaussian fitting, and for visual clarity, the curves are vertically offset; (k) shows features less than 100 nm observed by V-PEARL in yeast cells; and (m) is a profile intensity diagram in (k) and Gaussian fitting, and a scale in the figure is 1 μm.

### DETAILED DESCRIPTION OF THE EMBODIMENTS

In order to make the objects, technical solutions and advantages of the present invention clearer, the present invention will be further described in detail below in conjunction with the accompanying drawings and embodiments. It should be understood that the specific implementations described herein are only used to explain the present invention, and do not limit the scope of protection of the present invention.

Aiming at the problems that the existing fluorescence super-resolution imaging relies on fluorescent labeling, but the cytotoxicity of fluorescent labeling molecules, low labeling efficiency, and the difficulty of labeling small molecules and other limitations lead to the limitation of super-resolution imaging, as well as the problems that the risk of photodamage caused by the high laser light power required in label-free super-resolution imaging and the limitations of its application in organisms, an embodiment provides a non-fluorescent molecular super-resolution imaging system based on a photothermal relaxation localization microscope. Through the system, super-resolution imaging does not require additional fluorescent labeling, and the application scenarios are expanded to any molecules or structures with optical absorption, which has irreplaceable value in research and application fields such as biology, medicine, materials, and physics.

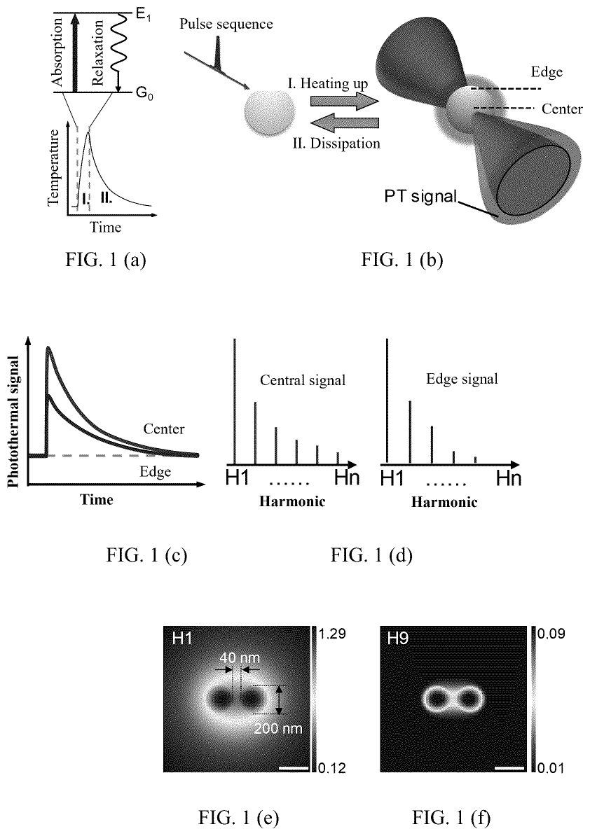

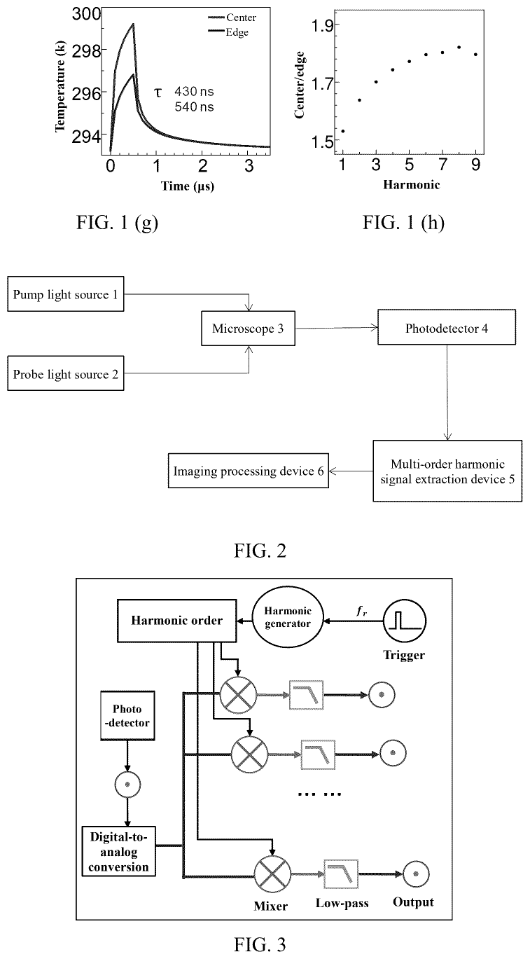

Through research, it has been found that the optical diffraction limit is broken by optically detecting the uneven photothermal relaxation, and this technology is called photothermal relaxation localization (PEARL). The concept of the PEARL microscope is the localization of the time characteristics of the photothermal relaxation process. The photothermal process generated by the excitation of the pulsed pump light includes two steps: the heating stage generated by vibrational absorption and the photothermal energy dissipation stage generated by thermal relaxation, which are the heating stage I and the photothermal dissipation stage II in FIG. 1 (a). In a homogeneous sample, although the energy absorbed by the molecules per unit volume is constant, the final photothermal heating effect is different. This is because the absorbed energy tends to be converted into photoacoustic components at the edges through expansion, as shown in FIG. 1 (b-c). This photothermal energy dissipation evolves in space and time and is detected by the focal spot of the probe light. The signal at high frequencies decreases more rapidly at the edges, as shown in FIG. 1 (d). This characteristic can be extracted in the frequency domain, and there are various extraction methods, one of which is to perform high-order harmonic demodulation through a lock-in amplifier.

In order to further elaborate the super-resolution imaging mechanism of PEARL, an embodiment provides the results of the resolution improvement of PEARL obtained through computational simulation. The sample is modeled as two polymethyl methacrylate (PMMA) microspheres with a diameter of 200 nm and a distance of 40 nm therebetween. The high-order harmonic components of the temperature evolution field are extracted through the fast Fourier transform, and the final result shows a significant resolution improvement, as shown in FIG. 1 (d). Moreover, there are obvious differences in the time evolution of the photothermal relaxation between the center and the edge of the microsphere. The ratio between the center and the edge also increases in the high-order harmonics, indicating a clear resolution improvement, as shown in FIG. 1 (g-h).

Based on the above, an embodiment provides a non-fluorescent molecular super-resolution imaging system based on a photothermal relaxation localization microscope, as shown in FIG. 2, including a pump light source 1, a probe light source 2, a microscope 3, a photodetector 4, a multi-order harmonic signal extraction device 5, and an imaging processing device 6.

A stage of the microscope 3 carries a sample to be tested and is capable of performing three-dimensional spatial displacement scanning on the sample to be tested, and the microscope is equipped with at least one objective lens for focusing laser light, so that focal points of pump light and probe light overlap; the pump light source 1 provides pump light in a pulse form, the pump light is focused on the sample to be tested through the objective lens, the sample to be tested selectively absorbs the pump light, and then dissipates energy through photothermal relaxation, generating a photothermal lens effect; the probe light source 2 provides continuous probe light, the probe light is focused by the objective lens and irradiated onto the sample to be tested having been acted upon by the pump light, the action of the pump light causes spatial and temporal changes, i.e., modulation, in the probe light, and characteristics of the modulation exhibited in a frequency domain are mainly manifested as follows: at a high-order harmonic frequency, a smaller spatial structure is capable of being detected, and a diffraction limit resolution of the probe light is capable of being exceeded; the photodetector 4 collects modulated probe light, and converts the modulated probe light into an electrical signal, and then inputs the electrical signal into the multi-order harmonic signal extraction device; as shown in FIG. 3, the multi-order harmonic signal extraction device 5 mixes the electrical signal with a sinusoidal signal of a harmonic frequency output by a harmonic generator, and then extracts a multi-order harmonic signal through low-pass filtering, and the multi-order harmonic signal is linearly related to intensity of the pump light; and the imaging processing device 6 is configured to perform super-resolution imaging according to multi-order harmonic signals.

When the microscope 1 is configured to perform three-dimensional spatial displacement scanning on the sample to be tested, the photodetector 4 collects probe light at a scanned position of each pixel in real time and converts the probe light into an electrical signal. The multi-order harmonic signal extraction device 5 extracts a multi-order harmonic signal from the electrical signal in real time. The multi-order harmonic signal includes signals from a fundamental frequency (H1) signal to a high-order harmonic (H25) signal and an even higher-order harmonic signal. Harmonic signals (voltage values) of a same order at all pixel positions of the sample to be tested are integrated to form an image, corresponding to a certain resolution. An image with a higher resolution is formed when an order is higher. Until the resolution reaches about 100 nm, images with sequentially increasing resolutions form an image sequence.

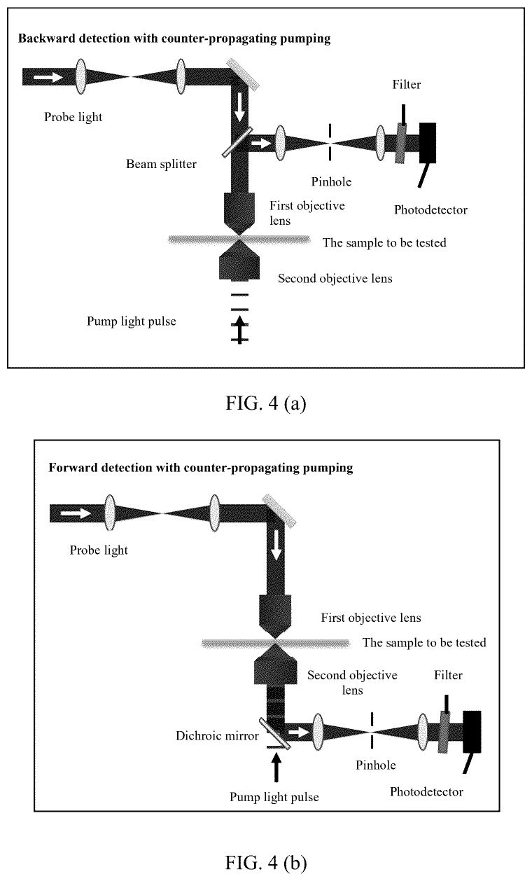

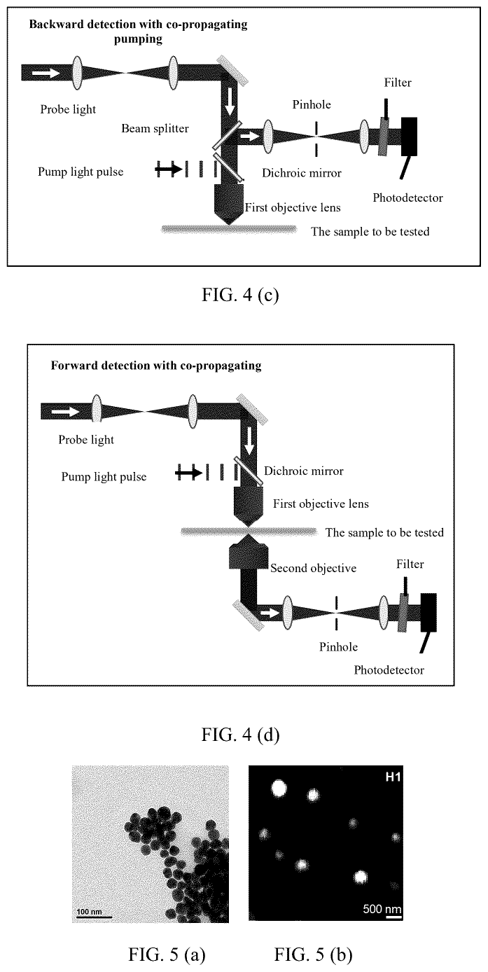

As shown in FIG. 4, four different detection modes are achieved by constructing different detection optical paths.

As shown in FIG. 4 (a), the super-resolution imaging system includes a first detection optical path, and a first detection mode is realized based on the first detection optical path, where in the first detection mode, the probe light of the probe light source and the pump light of the pump light source are opposite in direction in the objective lens, and the probe light performs backscattering detection on the sample to be tested, briefly referred to as backscattering detection with counter-propagating pumping; and the first detection optical path is as follows: the pump light output by the pump light source is focused onto the sample to be tested through a second objective lens, the probe light output by the probe light source is transmitted through a beam splitter into a first objective lens, and is focused by the first objective lens and irradiated onto the sample to be tested having been acted upon by the pump light, the probe light modulated by the sample to be tested is reflected back to the beam splitter, and is reflected by the beam splitter and then focused by a lens and passes through a pinhole, and is then filtered by a filter and then received by the photodetector. The adopted pinhole structure is configured for confocal focusing of the probe light to achieve spatial filtering, especially to improve the Z-axis resolution, and thus to enhance the quality of the laser spot.

As shown in FIG. 4 (b), the super-resolution imaging system includes a second detection optical path, and a second detection mode is realized based on the second detection optical path, where in the second detection mode, the probe light of the probe light source and the pump light of the pump light source are opposite in direction in the objective lens, and the probe light performs forward detection on the sample to be tested, briefly referred to as forward detection with counter-propagating pumping; and the second detection optical path is as follows: the pump light output by the pump light source is transmitted through a dichroic mirror into a second objective lens, and is focused on the sample to be tested through the second objective lens, the probe light output by the probe light source is focused by a first objective lens and irradiated onto the sample to be tested having been acted upon by the pump light, and the probe light modulated by the sample to be tested penetrates the sample to be tested and then enters the dichroic mirror through the second objective lens, and is reflected by the dichroic mirror and then focused by a lens and passes through a pinhole, and is then filtered by a filter and then received by the photodetector. The function of the pinhole here is for confocal detection to improve the Z-axis resolution.

As shown in FIG. 4 (c), the super-resolution imaging system includes a third detection optical path, and a third detection mode is realized based on the third detection optical path, where in the third detection mode, the probe light of the probe light source and the pump light of the pump light source are in a same direction in the objective lens, and the probe light performs backscattering detection on the sample to be tested, briefly referred to as backscattering detection with co-propagating pumping; and the third detection optical path is as follows: the pump light output by the pump light source is reflected by a dichroic mirror into a first objective lens, and is focused on the sample to be tested through the first objective lens, the probe light output by the probe light source is transmitted through a beam splitter and then transmitted through the dichroic mirror into the first objective lens, and is focused by the first objective lens and irradiated onto the sample to be tested having been acted upon by the pump light, and the probe light modulated by the sample to be tested is reflected back to the dichroic mirror by the first objective lens, transmitted through the dichroic mirror and then reflected by the beam splitter, focused by a lens and passes through a pinhole, and is then filtered by a filter and then received by the photodetector.

As shown in FIG. 4 (d), the super-resolution imaging system includes a fourth detection optical path, and a fourth detection mode is realized based on the fourth detection optical path, where in the fourth detection mode, the probe light of the probe light source and the pump light of the pump light source are in a same direction in the objective lens, and the probe light performs forward detection on the sample to be tested, briefly referred to as forward detection with co-propagating pumping; and the fourth detection optical path is as follows: the pump light output by the pump light source is reflected by a dichroic mirror into a first objective lens, and is focused on the sample to be tested through the first objective lens, the probe light output by the probe light source is transmitted through the dichroic mirror into the first objective lens, and is focused by the first objective lens and irradiated onto the sample to be tested having been acted upon by the pump light, and the probe light modulated by the sample to be tested penetrates the sample to be tested, then passes through the second objective lens, is focused by a lens and passes through a pinhole into a filter, and is then filtered and then received by the photodetector.

In an embodiment, the photodetector can adopt a high-bandwidth photodiode. Forward or backward collection is performed on the probe light through the high-bandwidth photodiode. As shown in FIG. 4, the output end of the probe light is provided with a lens group for changing the propagation direction. The number and positions of the reflecting mirrors and transmitting lenses that specifically make up the lens group are not limited, as long as they can guide the transmission of the modulated probe light. The probe light output by the probe light source is first filtered by a single-mode optical fiber and then transmitted to the first objective lens through the optical path. Filtering through the single-mode optical fiber can improve the image quality of the imaging system.

In an embodiment, as shown in FIG. 4, the input end of the filter is provided with a lens group for focusing the optical path. Specifically, there is one pinhole between the two convex lenses included in the lens group. The pinhole is used for confocal detection of the probe light to eliminate the interference of stray light and specular reflection and improve the Z axis resolution.

As shown in FIG. 4 (a) and (b), in the non-fluorescent molecular super-resolution imaging system provided in the embodiment, the pump light and the probe light irradiating the sample to be tested are in opposite directions and collinear. Such a design can optimize the two laser lights with a large wavelength difference separately and make fine adjustments in space to make the two focal points overlap, thereby maximizing the photothermal signal. In addition, backscattering detection can be performed according to the actual situation, as shown in FIG. 4 (a) and (c).

In an embodiment, the multi-order harmonic signal extraction device adopts a multi-channel digital lock-in amplifier, and the multi-channel digital lock-in amplifier performs multi-order harmonic demodulation on the input electrical signal to extract a multi-order harmonic signal in the frequency domain; and when the multi-channel digital lock-in amplifier is utilized to perform multi-order harmonic demodulation on the input electrical signal, a fundamental frequency adopted is a pulse repetition frequency of the pump light source.

In the non-fluorescent molecular super-resolution imaging system provided in the embodiment, the pump light source emits pump light with visible to mid-infrared wavelengths. The pump light within such a wavelength range can detect a variety of different molecules. In an embodiment, for the pump light with mid-infrared wavelengths, the objective lens of the microscope adopted is a reflective objective lens, such as a Cassegrain objective lens or a Schwarzschild objective lens, and the objective lens is configured to perform focusing optimization on focusing of the pump light in a mid-infrared band. For the probe light, the objective lens of the microscope adopted can be a high numerical aperture objective lens, and the high numerical aperture objective lens is configured to perform focusing optimization on focusing of the probe light and improve the resolution.

The following describes the imaging application of the above non-fluorescent molecular super-resolution imaging system in conjunction with specific samples to be tested.

When photothermal relaxation localization imaging based on electronic absorption, briefly referred to as E-PEARL imaging, is performed with visible light pumping, a pulsed nanosecond laser with a wavelength of 532 nm is used as the pump light source, and a continuous-wave laser with a wavelength of 638 nm is used as the probe light source. After the pump light emitted by the pump light source and the probe light emitted by the probe light source are combined collinearly, they are sent to the first objective lens of the microscope. As shown in FIG. 4 (c), the light beam is focused by the first objective lens and then irradiated onto the sample to be tested on the stage to scan the sample to be tested. The sample to be tested vibrationally absorbs the pump light, generates a photothermal effect, and then dissipates photothermal energy through photothermal relaxation, generating a photothermal lens effect. The probe light is focused by the objective lens and irradiated onto the sample to be tested having been acted upon by the pump light, the action of the pump light causes spatial and temporal changes, i.e., modulation, in the probe light, and characteristics of the modulation exhibited in a frequency domain are mainly manifested as follows: at a high-order harmonic frequency, a smaller spatial structure is capable of being detected, and a diffraction limit resolution of the probe light is capable of being exceeded. The time-modulated probe light is collected and converted by the photodetector and then input into the multi-channel digital lock-in amplifier. The multi-channel digital lock-in amplifier performs multi-order harmonic demodulation on the input probe light. As shown in FIG. 3, the fundamental frequency (i.e., the first-order harmonic) adopted during demodulation is the repetition frequency of the pump light source, i.e., the number of pulses emitted by the pulsed laser light per second. During demodulation, any order of harmonics (nth harmonic order, n=1, 2, . . . , n) can be selected for demodulation to extract the amplitude and relative phase of each channel. After the probe light is converted into an electrical signal by the photodiode, it can be collected through high-speed digitalized digital-to-analog conversion, thereby performing digital demodulation of any harmonic. Any number of harmonic signals can be executed without loss, and then the high-order harmonic signals are utilized for super-resolution imaging to obtain new and clearer images, without affecting the traditional photothermal image at the fundamental frequency.

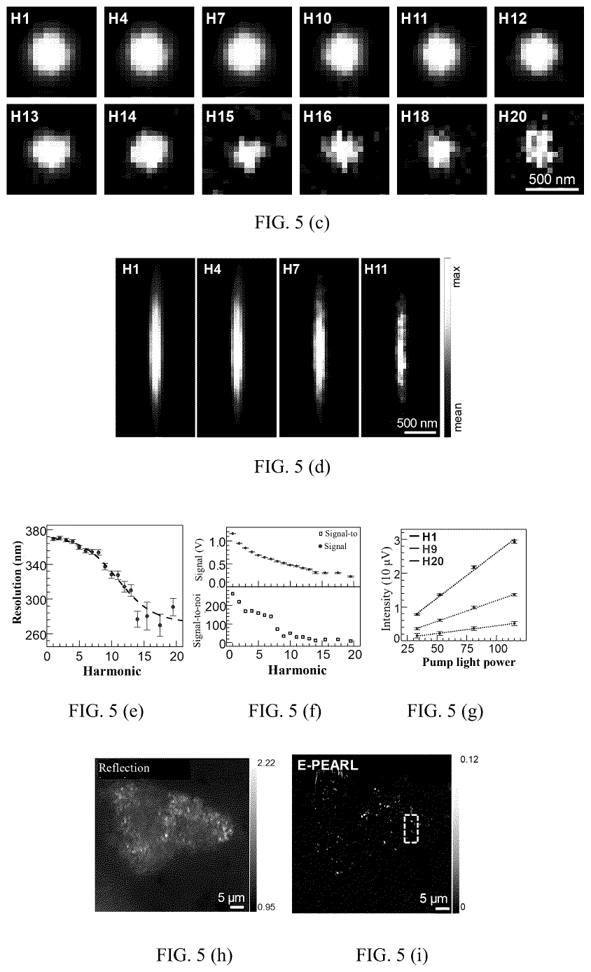

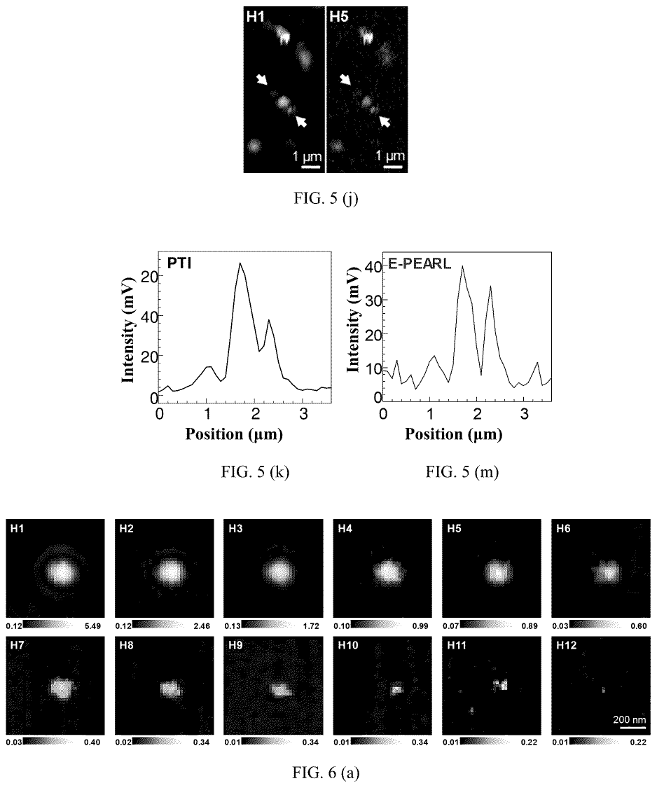

In an embodiment, the performance study and cellular application of E-PEARL imaging were performed on the gold nanoparticles (AuNPs) with a wide absorption band and low cytotoxicity as shown in FIG. 5 (a). Compared with the traditional diffraction-limited photothermal imaging shown in FIG. 5 (b), the spatial resolution of E-PEARL imaging at high-order harmonics was significantly improved, exceeding the diffraction limit both laterally and axially, as shown in FIG. 5 (c-e). The resolution ranged from 370 nm to 270 nm, and the lateral resolution was increased by a factor of 1.4, exceeding the diffraction limit of the probe light. Limited by the bandwidth of the photodetector and the multi-channel digital lock-in amplifier, signals with harmonic orders higher than 22 (11 MHz) were not collected. As long as the bandwidths of the photodetector and the multi-channel digital lock-in amplifier are sufficient, harmonic signals with orders higher than 22 can be collected. The added series of new images not only has higher resolution at higher harmonic orders, but also provides the possibility of further improving the image quality through multi-dimensional image processing.

As shown in FIG. 5 (f), the harmonic signal of E-PEARL imaging showed a high degree of linear dependence on the pump power, which indicates that PEARL is different from the super-resolution imaging mode based on nonlinear signal generation and has a unique mechanism. Nonlinear signals are generated by high-order thermal disturbances or nonlinear absorption, such as saturation, nonlinear resonance, etc., and occur under the excitation of extremely high pump light power. Therefore, these modes require pump light with a strict sinusoidal waveform, where any parasitic frequency component will lead to an unnecessary background. In contrast, the PEARL signal originates from the harmonic signal of the relaxation curve and should be linearly related to the intensity of the pump light. This relationship avoids the use of high-power laser pulses and is applicable to a wider range of absorption scenarios.

In an embodiment, the application of E-PEARL imaging in biological systems was demonstrated by imaging the uptake of AuNPs by cancer cells, as shown in FIG. 5 (h)-(i). The cellular uptake of nanostructures has been widely applied to photothermal imaging in biology and medicine, such as disease markers. Compared with unmodulated reflection imaging, photothermal imaging has the advantage of high photothermal conversion of AuNPs, and photothermal imaging can obtain the distribution of AuNPs within cells with high contrast. Through the detailed comparison in FIG. 5 (j), (k) and (m), E-PEARL imaging was superior to conventional photothermal imaging in terms of spatial resolution, providing a new method for the cellular distribution of nanostructures and material imaging.

When photothermal relaxation localization imaging was performed with mid-infrared pumping and visible light detection, that is, a PEARL microscope for vibrational spectroscopy, briefly referred to as V-PEARL imaging, was performed, the probe light with a wavelength of 405 nm emitted by the probe light source served as a balance between the diffraction limit resolution and the photodamage caused by high photon energy, and due to its shorter wavelength, it increased the scattering, raised the number of photons in the backscattering detection mode, and further improved the signal-to-noise ratio. The Cassegrain objective lens and the high numerical aperture objective lens were adopted to perform focusing optimization on the focusing of the pump beam and the probe beam, respectively, and the two beams propagated in opposite directions. The photothermally modulated probe beam can be collected through the forward or backscattering detection mode of the high-bandwidth photodiode. Here, in order to eliminate the interference of stray light and specular reflection, one pinhole was placed confocally on the backscattering detection path.

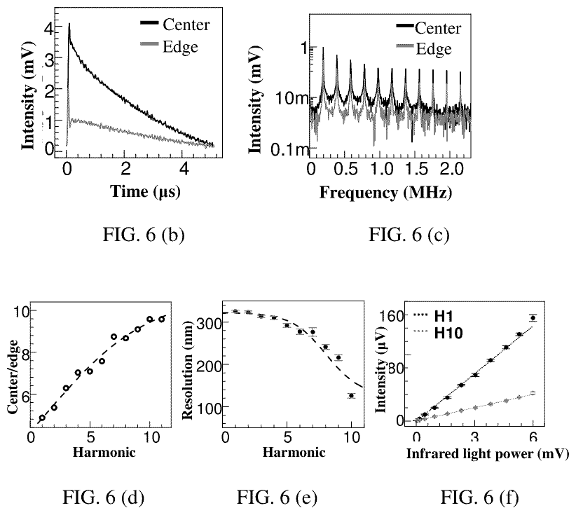

Furthermore, to test the resolution, V-PEARL imaging was performed on polymethyl methacrylate (PMMA) microspheres with an average size of 200 nm, as shown in FIG. 6 (a). The infrared pump wavelength was set at the 1730 cm⁻¹ C═O stretching vibration peak. The full width at half maximum (FWHM) of the PMMA microspheres in the reflected image was approximately 310 nm, while the FWHM measured in the V-PEARL image decreased from 325±3 nm to 126±6 nm at the 10th harmonic, as shown in FIG. 6 (e). At higher harmonics, the signal-to-noise ratio was reduced by about 2.8 times, but a 2.6-fold improvement in resolution was achieved. Nevertheless, considering the high signal level of infrared absorption and the reduction of 1/f noise at high-order harmonics, such a compromise was experimentally worthwhile for improving the resolution.

In an embodiment, the photothermal relaxation of the probe beam at the center and edge positions of a single 2 μm PMMA microsphere was also measured, as shown in FIG. 6 (b)-(d). The relaxation at both positions consisted of a heating and a dissipation process: one was a rapid dissipation on a time scale of tens of nanoseconds, and the other was a long-time dissipation on a microsecond scale. The rapid dissipation part was mainly due to photoacoustic transfer. The intensity at the center of the microsphere decreased by 16%, and at the edge, it decreased by 68%, indicating the difference in photothermal conversion efficiency. The other part was a slower exponential decay-type relaxation, with relaxation times at the center and edge of 3.8 μs and 6.7 μs, respectively. The photothermal relaxation can be described as a Fourier series of various harmonic components as shown in the FFT waveform, as shown in FIG. 6 (c), and the intensity ratio between the center and the edge increased at high-order harmonics, as shown in FIG. 6 (d). This was consistent with the simulation results. In addition, the linear power dependence of the V-PEARL signal was verified in an embodiment, as shown in FIG. 6 (f).

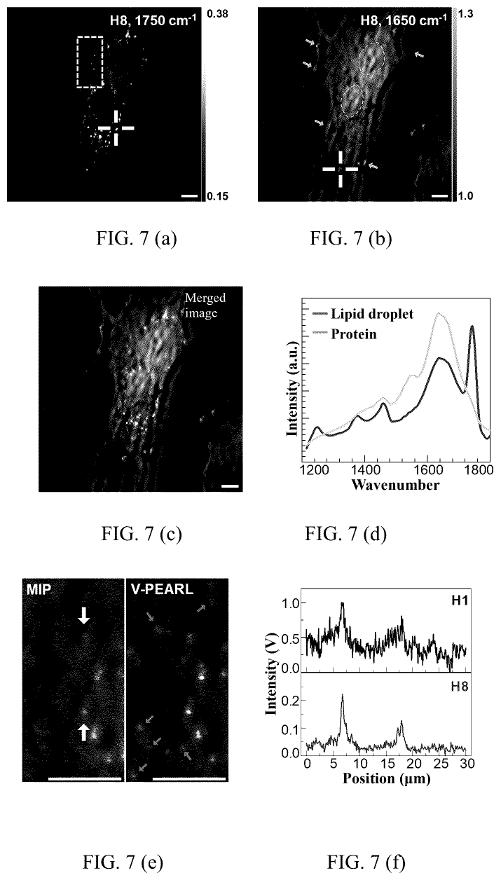

An embodiment further demonstrated the application of V-PEARL in mammalian cell imaging. The physiological functions of organelles are directly regulated by their spatial distribution, and the distribution of organelles is finely controlled by the transport mediated by the cytoskeleton. Lipid droplets (LDs) have become an important organelle and play a crucial role in the survival and state of cells. As a multifunctional organelle, the LD functions as an energy storage unit, a storage space for toxic metabolites, or a signal transduction platform, and its distribution is the key to determining its function. Fluorescence-based super-resolution imaging has made great contributions to revealing the mechanisms of organelle transport and interaction. However, not all biomolecules or organelles can be effectively fluorescently labeled, and they are often significantly affected by the labeling molecules. Here, an embodiment used super-resolution infrared imaging of mammalian cells to demonstrate label-free organelle tracing. V-PEARL imaging was performed on chondrocytes cultured for three days at the symmetric vibration peak of 1750 cm⁻¹ lipid C═O and the peak of the 1650 cm⁻¹ amide I band of proteins, with a demodulation wavenumber of the 8th order, as shown in FIG. 7 (a)-(c). In an embodiment, it was found that a large number of LDs accumulated within the cells, as shown in FIG. 7 (a) and (c). Most of the protein signals were distributed in the cytoplasm and the nucleus, showing that the chondrocytes were spindle-shaped. Moreover, some protein droplets were also observed, as shown in FIG. 7 (b). In an embodiment, it is also found that the LDs were closely localized along the cytoskeleton, as shown in FIG. 7 (c), which indicates that the LDs are transported through these protein-rich structures. The in-situ infrared photothermal spectra of the LDs and protein droplets verified their molecular structures, as shown in FIG. 7 (d). Importantly, V-PEARL can resolve more features of small LDs with a size of 300-400 nm, which cannot be achieved by traditional MIP imaging (MIP, H1) due to insufficient resolution, as shown in FIG. 7 (e) and (f). It has great potential in both the spatial and spectral visualization of organelles for which it is difficult to label or obtain molecular information.

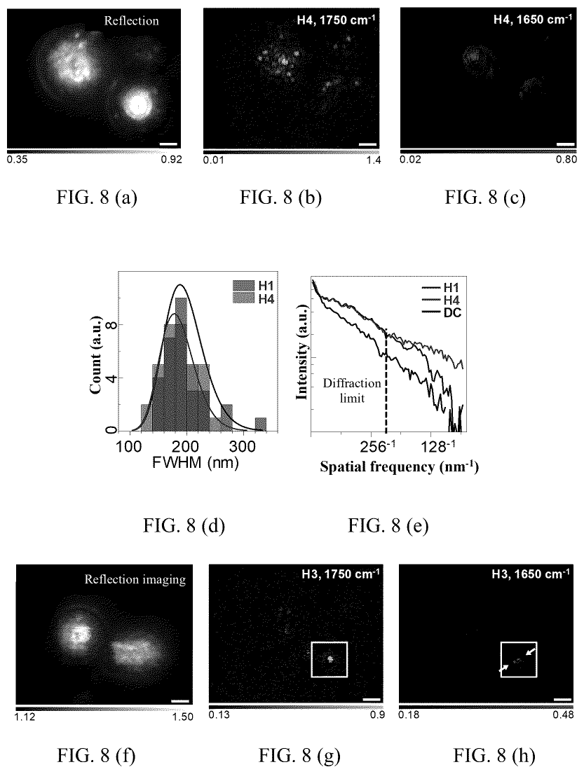

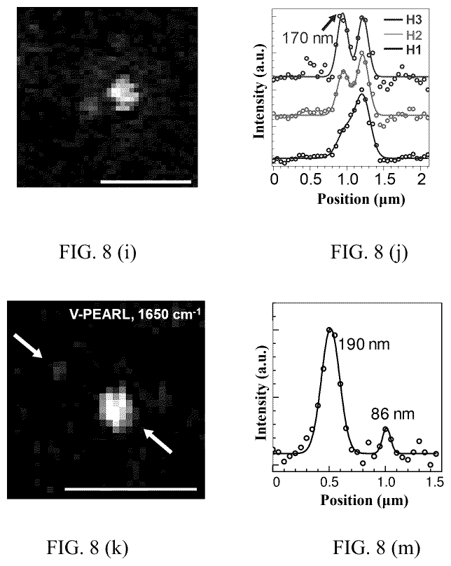

This embodiment further provided V-PEARL super-resolution imaging of yeast cells. Yeast is a powerful model organism for studying cell biology, especially lipid metabolism. However, when the size of a single yeast cell is approximately 2-4 μm, a major limitation is the lack of tools to visualize tiny LDs (generally 0.05-0.5 μm). An embodiment used the V-PEARL microscope for the first time to perform subcellular far-field infrared imaging of yeast cells. Yeast cells contained sparse LDs, which were not obvious in the reflected image, as shown in FIG. 8 (a). In the fourth harmonic V-PEARL imaging, single LDs were visible at 1750 cm⁻¹, while protein signals were found in the 1650 cm⁻¹ amide I band, as shown in FIG. 8 (b) and (c). This embodiment also measured the size distribution of intracellular LDs, as shown in FIG. 8 (d), showing a significant difference in the histograms of LD sizes between the 1st and 4th harmonic demodulations. The average size of these LDs was 197±19 nm at the 1st-order demodulation (traditional MIP) and 185±16 nm at the 4th-order demodulation. In addition, the spatial frequency distributions of the imaging diagrams were compared. V-PEARL showed more abundant spatial frequency components, especially at higher spatial frequencies, which represented a higher spatial resolution, as shown in FIG. 8 (e). In addition, V-PEARL imaging revealed a subtle spatial separation structure between small LDs and a pair of protein droplets (each approximately 170 nm), as shown in FIG. 8 (i). Compared with the theoretical infrared resolution at 1650 cm⁻¹, the resolution of this method was increased by 43.5 times. Meanwhile, the line profile and Gaussian fitting showed a trend of resolution improvement at the 2nd and 3rd harmonics. In contrast, only a single peak with a slight shoulder was found in the conventional MIP, as shown in FIG. 8 (j). In addition, the smallest feature observed in the V-PEARL imaging of yeast was approximately 86 nm, which was the first time that features below 100 nm had been resolved by far-field infrared imaging, as shown in FIG. 8 (k) and (m).

The specific implementations described above have described the technical solutions and beneficial effects of the present invention in detail. It should be understood that the above are only the most preferred embodiments of the present invention and are not intended to limit the present invention. Any modifications, supplements, equivalent substitutions, etc. made within the scope of the principles of the present invention shall be included in the scope of protection of the present invention.

1. A non-fluorescent molecular super-resolution imaging system based on a photothermal relaxation localization microscope, comprising a pump light source, a probe light source, a microscope, a photodetector, a multi-order harmonic signal extraction device, and an imaging processing device,
wherein a stage of the microscope carries a sample to be tested and is capable of performing three-dimensional spatial displacement scanning on the sample to be tested, and the microscope is equipped with at least one objective lens for focusing laser light, so that focal points of a pump light and a probe light overlap;
the pump light source provides the pump light in a pulse form, the pump light is focused on the sample to be tested through the objective lens, the sample to be tested selectively and linearly absorbs the pump light, and performs energy dissipation through photothermal relaxation, and a time characteristic localization is performed in the process of the energy dissipation;
the probe light source provides continuous probe light, the probe light is focused by the objective lens and irradiated onto the sample to be tested having been acted upon by the pump light, the action of the pump light causes spatial and temporal changes, i.e., modulation, in the probe light, and characteristics of the modulation exhibited in a frequency domain are mainly manifested as follows: at a high-order harmonic frequency, a smaller spatial structure is capable of being detected, and a diffraction limit resolution of the probe light is capable of being exceeded;
the photodetector collects modulated probe light, and converts the modulated probe light into an electrical signal, and then inputs the electrical signal into the multi-order harmonic signal extraction device;
the multi-order harmonic signal extraction device mixes the electrical signal with a sinusoidal signal of a harmonic frequency output by a harmonic generator, and then extracts a multi-order harmonic signal through low-pass filtering, and the multi-order harmonic signal is linearly related to intensity of the pump light; and
the imaging processing device performs super-resolution imaging according to multi-order harmonic signals extracted during the three-dimensional spatial displacement scanning, each order of harmonic signal forms an image, wherein an image with a higher resolution is formed when an order is higher, and images with sequentially increasing resolutions form an image sequence.

2. The non-fluorescent molecular super-resolution imaging system based on a photothermal relaxation localization microscope according to claim 1, wherein the super-resolution imaging system comprises a first detection optical path, and a first detection mode is realized based on the first detection optical path, wherein in the first detection mode, the probe light of the probe light source and the pump light of the pump light source are opposite in direction in the objective lens, and the probe light performs backscattering detection on the sample to be tested; and
the first detection optical path is as follows: the pump light output by the pump light source is focused onto the sample to be tested through a second objective lens, the probe light output by the probe light source is transmitted through a beam splitter into a first objective lens, and is focused by the first objective lens and irradiated onto the sample to be tested having been acted upon by the pump light, the probe light modulated by the sample to be tested is reflected back to the beam splitter, and is reflected by the beam splitter and then focused by a lens and passes through a pinhole, and is then filtered by a filter and then received by the photodetector.

3. The non-fluorescent molecular super-resolution imaging system based on a photothermal relaxation localization microscope according to claim 1, wherein the super-resolution imaging system comprises a second detection optical path, and a second detection mode is realized based on the second detection optical path, wherein in the second detection mode, the probe light of the probe light source and the pump light of the pump light source are opposite in direction in the objective lens, and the probe light performs forward detection on the sample to be tested; and
the second detection optical path is as follows: the pump light output by the pump light source is transmitted through a dichroic mirror into a second objective lens, and is focused on the sample to be tested through the second objective lens, the probe light output by the probe light source is focused by a first objective lens and irradiated onto the sample to be tested having been acted upon by the pump light, and the probe light modulated by the sample to be tested penetrates the sample to be tested and then enters the dichroic mirror through the second objective lens, and is reflected by the dichroic mirror and then focused by a lens and passes through a pinhole, and is then filtered by a filter and then received by the photodetector.

4. The non-fluorescent molecular super-resolution imaging system based on a photothermal relaxation localization microscope according to claim 1, wherein the super-resolution imaging system comprises a third detection optical path, and a third detection mode is realized based on the third detection optical path, wherein in the third detection mode, the probe light of the probe light source and the pump light of the pump light source are in a same direction in the objective lens, and the probe light performs backscattering detection on the sample to be tested; and
the third detection optical path is as follows: the pump light output by the pump light source is reflected by a dichroic mirror and input into a first objective lens, and is focused on the sample to be tested through the first objective lens, the probe light output by the probe light source is transmitted through a beam splitter and then transmitted through the dichroic mirror and input into the first objective lens, and is focused by the first objective lens and irradiated onto the sample to be tested having been acted upon by the pump light, and the probe light modulated by the sample to be tested is reflected back to the dichroic mirror by the first objective lens, transmitted through the dichroic mirror and then reflected by the beam splitter, focused by a lens and passes through a pinhole, and is then filtered by a filter and then received by the photodetector.

5. The non-fluorescent molecular super-resolution imaging system based on a photothermal relaxation localization microscope according to claim 1, wherein the super-resolution imaging system comprises a fourth detection optical path, and a fourth detection mode is realized based on the fourth detection optical path, wherein in the fourth detection mode, the probe light of the probe light source and the pump light of the pump light source are in a same direction in the objective lens, and the probe light performs forward detection on the sample to be tested; and
the fourth detection optical path is as follows: the pump light output by the pump light source is reflected by a dichroic mirror into a first objective lens, and is focused on the sample to be tested through the first objective lens, the probe light output by the probe light source is transmitted through the dichroic mirror into the first objective lens, and is focused by the first objective lens and irradiated onto the sample to be tested having been acted upon by the pump light, and the probe light modulated by the sample to be tested penetrates the sample to be tested, then passes through the second objective lens, is focused by a lens and passes through a pinhole into a filter, and is then filtered and then received by the photodetector.

6. The non-fluorescent molecular super-resolution imaging system based on a photothermal relaxation localization microscope according to claim 2, wherein the probe light output by the probe light source is first filtered by using a single-mode optical fiber and then transmitted through an optical path to the first objective lens.

7. The non-fluorescent molecular super-resolution imaging system based on a photothermal relaxation localization microscope according to claim 1, wherein the probe light source emits continuous probe light of ultraviolet and visible light.

8. The non-fluorescent molecular super-resolution imaging system based on a photothermal relaxation localization microscope according to claim 1, wherein the multi-order harmonic signal extraction device adopts a multi-channel digital lock-in amplifier, and the multi-channel digital lock-in amplifier performs multi-order harmonic demodulation on the input electrical signal to extract a multi-order harmonic signal in the frequency domain; and
when the multi-channel digital lock-in amplifier is utilized to perform multi-order harmonic demodulation on the input electrical signal, a fundamental frequency adopted is a pulse repetition frequency of the pump light source.

9. The non-fluorescent molecular super-resolution imaging system based on a photothermal relaxation localization microscope according to claim 1, wherein for mid-infrared light, the objective lens adopted is a reflective objective lens, comprising a Cassegrain objective lens and a Schwarzschild objective lens, and the reflective objective lens is configured to perform focusing optimization on focusing of the pump light in a mid-infrared band.

10. The non-fluorescent molecular super-resolution imaging system based on a photothermal relaxation localization microscope according to claim 1, wherein the objective lens adopted is a high numerical aperture objective lens, comprising an air lens, a water immersion objective lens, and an oil immersion objective lens, and the high numerical aperture objective lens is configured to perform focusing optimization on focusing of the probe light.

11. The non-fluorescent molecular super-resolution imaging system based on a photothermal relaxation localization microscope according to claim 3, wherein the probe light output by the probe light source is first filtered by using a single-mode optical fiber and then transmitted through an optical path to the first objective lens.

12. The non-fluorescent molecular super-resolution imaging system based on a photothermal relaxation localization microscope according to claim 4, wherein the probe light output by the probe light source is first filtered by using a single-mode optical fiber and then transmitted through an optical path to the first objective lens.

13. The non-fluorescent molecular super-resolution imaging system based on a photothermal relaxation localization microscope according to claim 5, wherein the probe light output by the probe light source is first filtered by using a single-mode optical fiber and then transmitted through an optical path to the first objective lens.
